(19) United States
(12) Patent Application Publication
(10) Pub. No.: US 2011/0247394 A1
(43) Pub. Date: Oct. 13, 2011

(54) SEGREGATION SYSTEM FOR FLUID ANALYSIS

(75) Inventor: Adam Dewey McBrady, Minneapolis, MN (US)

(73) Assignee: HONEYWELL INTERNATIONAL INC., Morristown, NJ (US)

(21) Appl. No.: 12/757,895

(22) Filed: Apr. 9, 2010

(51) Int. Cl. G01N 30/02

(52) U.S. Cl. 73/23.41

(57) ABSTRACT

An approach for analyzing fluid samples. The approach provides for segregating a sample into groups of analytes in a sample before being passed on to an analyzer such as a detector or separator. The sample may be run through a number of collectors connected in series each of which may adsorb analytes having a certain property which is different from a property of any of the other collectors in the series. After the adsorption of analytes, the collectors may be reconnected by a valve or fluid control mechanism from their series connection to a parallel connection to their respective analyzers. The analytes may be desorbed into a pulse in each of the collectors, which goes to the respective analyzer.

The U.S. Government may have rights in the present invention.

### BACKGROUND

The invention pertains to fluid analysis, and particularly to approaches and devices for gas or liquid analysis.

### SUMMARY

The invention is an approach for analyzing fluid samples. The approach provides for segregating a sample into groups of analytes in a sample before being passed on to an analyzer or separator. The sample may be run through a number of collectors connected in series each of which may adsorb analytes having a certain property which is different from a property of any of the other collectors in the series. After the adsorption of analytes, the collectors may be reconnected by valves, fluid control mechanisms or mechanism, from their series connection to a parallel connection to their respective analyzers. The analytes may be desorbed into a pulse in each of the respective collectors, which goes to the respective analyzer.

### BRIEF DESCRIPTION OF THE DRAWING

FIG. 1 is a diagram of a set of valves connecting a set of collector in series;

FIG. 2 is a diagram of the set valves in FIG. 1 connecting the collectors in parallel to analyzers;

FIG. 3 is a diagram of device having collecting segments each of which serves has a separate temperature control mechanism;

FIG. 4 is a diagram of a graph showing collector data supporting the phenomenon of chemical segregation;

FIG. 5 is a diagram of a perspective of an illustrative example valve noted in the diagrams of FIGS. 1 and 2; and

FIGS. 6-9 are diagrams showing a collector using a phased temperature control array structure.

### DESCRIPTION

There is a variety of chromatographic analysis techniques for analyzing a gas sample. The techniques certified for use by the EPA, like TO-15, may assume a certain amount of a priori knowledge about the yet to be analyzed gas sample. This assumed knowledge may often include the identity and approximate concentration or collection of the target analytes for which one is analyzing. One technique may be very different from another depending on the sample type and expected concentration or collection. The differences may require an operator to change an instrument configuration (for example separation columns, injection techniques, detectors) to handle different sample types. These changes are often time consuming and complicated requiring significant time from a trained user. The end result may be an increased analysis cost. Moreover, there is no one technique or instrument capable of identifying or quantifying the components within a completely unknown gaseous sample.

The present approach may solve the requirement of having a priori knowledge about the sample. Thus, a solution may eliminate or reduce the operator requirement thereby lowering analysis cost and increasing the sample throughput.

The present approach may rely on segregating the gaseous sample into groups of analytes according to a chemical or physical property. Each group may therefore be comprised of very similar analytes. As an example, one may segregate an office-air sample by boiling point. The group of high boiling point compounds may contain semi-volatile organics (perfumes, phthalates, and the like), the mid-boiling point compounds may contain volatile organics (cleaning products, NH₃, and the like), the low boiling point compounds may contain permanent gases (Ar, CS2, CO2, and the like).

The present approach may employ temperature controlled PHASED™ devices. (“PHASED” is a Honeywell International Inc. acronym for “Phased Heater Array Structure for Enhanced Detection”.) Each PHASED device may perform as a concentrator/collector/injector. To take advantage of the multiple temperature zones, the PHASED devices should be connected in series during sampling (in that the output of the first device is connected to the input of the next).

The temperature controlled devices or components may cool an adsorbent material to sub-ambient conditions or heat the material to assist in a segregation process of the analytes in a fluid.

To be able to tailor the separation conditions for certain analytes that will be adsorbed by one specific device, the PHASED devices should then be arranged in a parallel arrangement (in that each PHASED output is connected to a unique separation column).

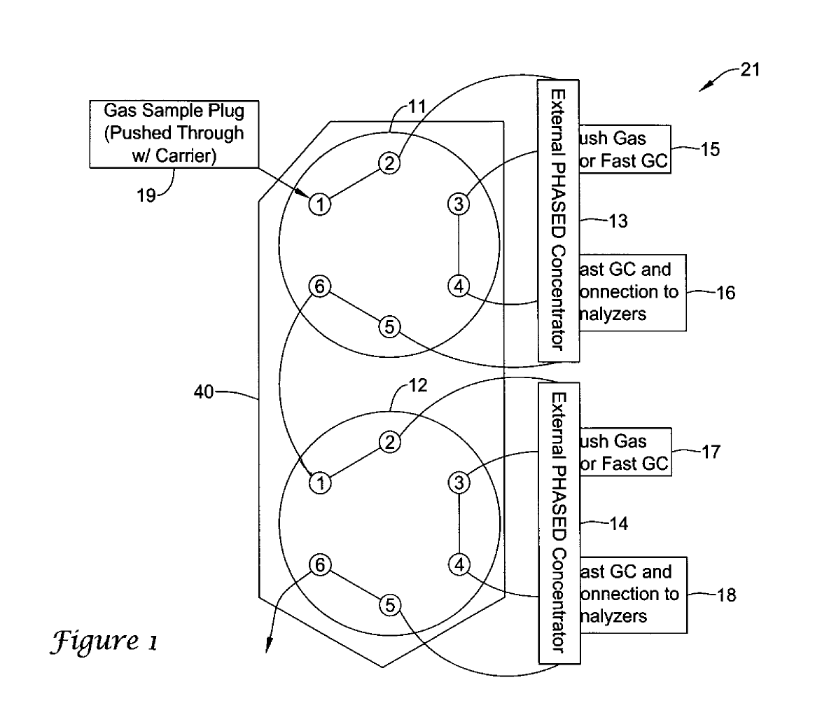

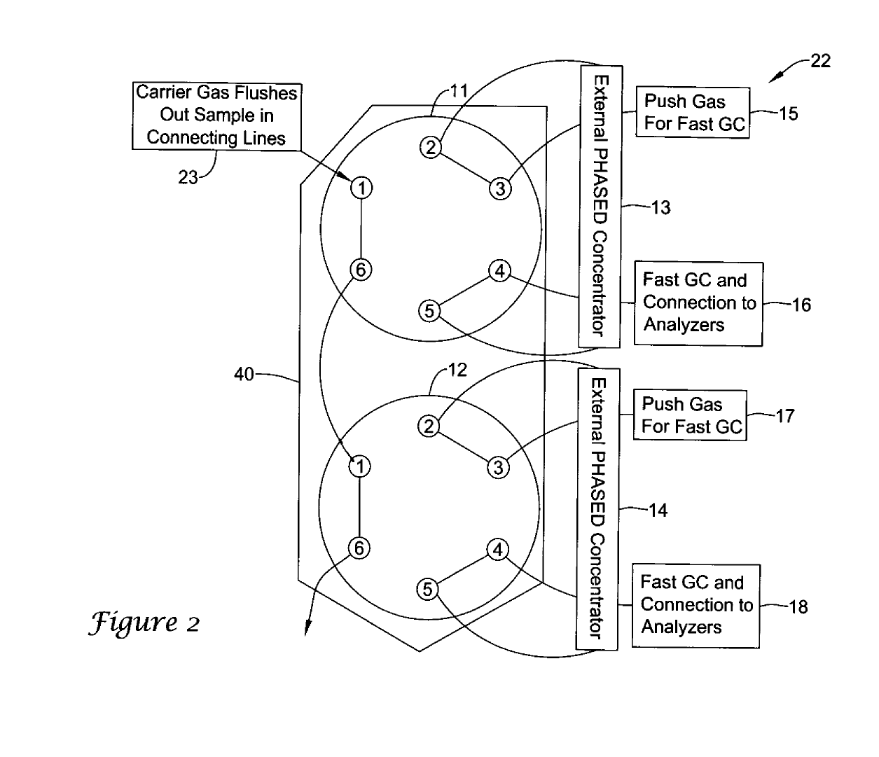

A realization of a series sampling arrangement 21 and then a parallel analysis arrangement 22 may be achieved by connecting the PHASED devices across 6-port, two-position valves 11 and 12 or fluid control mechanisms. The valves 11 and 12 or their substitutes together may be regarded as fluid mechanisms or collectively as a fluid mechanism 40. Instead, rather than the valves, there may be a non-valve fluid control mechanism 40. The arrangements are described in relation to FIGS. 1 and 2. These Figures highlight a fluidic configuration of two PHASED devices 13 and 14 using two 6-port, 2-position valves 11 and 12, which reveal serial sampling and parallel analysis valve positions. FIG. 1 shows that for sampling, valves 11 and 12 are in a position that fluidically connects ports 1&2, 3&4, and 5&6. The fluidic ports of PHASED (or any other sample loop) are connected across ports 2 and 5. During sampling, gas may enter port 1 of the top valve 11 and enter the PHASED device 13 at port 2. Within the temperature controlled PHASED device 13, certain analytes may be collected. The remaining gas sample may then enter the valve at port 5 and exit the top valve 11 at port 6. The sample may then enter the bottom valve 12 at port one and follow the same fluidic path. The difference in the bottom valve 12 is that the PHASED device 14 may collect (i.e., adsorb) a different aliquot of the sample due to its different temperature. In this manner, multiple PHASED devices may be connected in series to enable chemical segregation during sampling. Segregation as noted herein is not necessarily perfect, but may vary from about 50 percent to 95 percent and greater.

Actuation of valves 11 and 12 may transition the fluidic arrangement from the serial sample configuration 21 in FIG. 1 to the parallel analysis configuration 22 of FIG. 2. The valves may be replaced with one valve or a fluid control mechanism, fluid routing mechanism, or comparable item or items. The valves, the fluid control mechanism and the routing mechanism may have two or more selections, states or modes which may provide various connection arrangements among the devices, analyzers and the input and output ports of a segregation and analyzer system. The present valves are described herein for illustrative purposes. The 6-port, 2-position valves 11 and 12 may have different fluidic paths inside the valve. Ports 1&6, 2&3, and 4&5 may be connected. For analysis, the carrier gas that drives the sample into port 1 of the top valve 11 may flush out any remaining analytes in the connecting tubing between valves 11 and 12. The sample that is collected in the PHASED device 13 during sampling may be desorbed and introduced to the separation column connected at port 4. The carrier gas for injection and separation may be provided at port 3 of the valves 11 and 12. By arranging the fluidic connections in such manner and actuating valves 11 and 12 between sampling and analysis, one may realize serial sampling and parallel analysis relative to devices 13 and 14, which may be extended in the same manner to additional valves and PHASED devices. The present system may be expanded to encompass many devices, valves and analyzers. The devices (i.e., segregators), valves and analyzers in the present description are in pairs for illustrative purposes. Analyzers may be chemical or physical analyzers. Analyzers may perform separation, general chromatography or other detection on fluids from the devices. A chromatographic column or columns may be just an example or part of an analyzer.

PHASED injectors may be chemical segregators. A solution for dealing with increased sample complexity may be to chemically segregate the sample before chromatographic separation. The ability to chemically segregate may rely on passing the sample through a series of PHASED analyte concentrator/collectors/injectors. The chemical segregation may rely on each PHASED device containing a unique adsorbent which adsorbs just one class of analytes. The PHASED devices, the segregation sampling protocol, and the adsorbent development may be noted. A select number of proof-of-concept separations using PHASED concentrator/collector/injectors may be provided and critically analyzed.

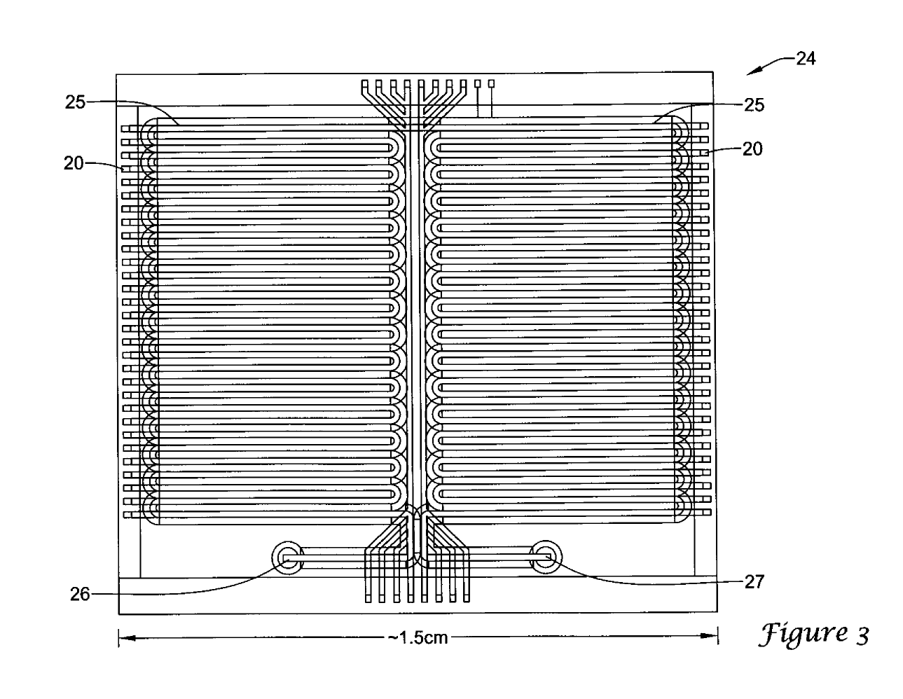

For example, there may be 24 PHASED chips per wafer. The device configuration may have 60 concentrating segments each of which serves as a separate heater. A schematic of one PHASED device 24 is shown in FIG. 3. The PHASED device may contain a serpentine channel that begins and ends on the bottom of the schematic in the Figure. The 60 concentrating elements 25 may be individually addressed via the 30 bond pads 20 seen on the left and right of the schematic. The heating elements may share a common ground connection. The ground bus may run down the middle of the chip and have bond pads at the top of the schematic. Individually addressing each heating element may be critical to being able to synchronize desorption of collected analytes with the flow rate through the channel. PHASED chip 24 may have an inlet 26 and an outlet 27.

“Absorption” and “adsorption”, or like terms, may have different meanings. Often in some contexts, “ad” may indicate surface sorption and “ab” may indicate sorption into the bulk of material. The term adsorbent or absorbent, and other forms of the term, may be used herein to mean both absorption and adsorption and like terms.

PHASED may be based on a large array of thermally isolated, individually addressed, gas adsorption-desorption heating elements. The heating elements may be unsupported, low-mass silicon nitride heaters that make up the bottom wall of a rectangular flow channel. The adsorbent material may be deposited directly on the surface of the heaters. The stationary phase materials may be deposited and patterned during MEMS fabrication before bonding the wafers together. This may be a critical parameter for realizing the cost savings from by MEMS batch fabrication and achieving a low cost per analysis. Upon gas introduction to the PHASED concentrator, the analytes may adsorb onto the adsorbent deposited within the channel. After adsorption, each heater element may fire in sequential order. The firing rate may be synchronized, or in phase, with the flow rate above the heaters. The synchronization may cause the analytes to desorb into the same volume of gas that contains the combined analytes from virtually all previous heating elements. Employing PHASED may enable precise, efficient, controlled injection of focused and concentrated analyte plugs into ultra-fast temperature programmable chromatographic columns. The injection widths coming out of a PHASED may be determined by the linear velocity of the gas moving through the device. At higher linear velocities, more rapid heating may be required to keep up with the flow rate. This may result in smaller injection widths. At high linear velocities in other programs, the PHASED device may produce injections as narrow as three milliseconds (fwhm). Narrow injection widths may be critical to realizing the high peak capacities.

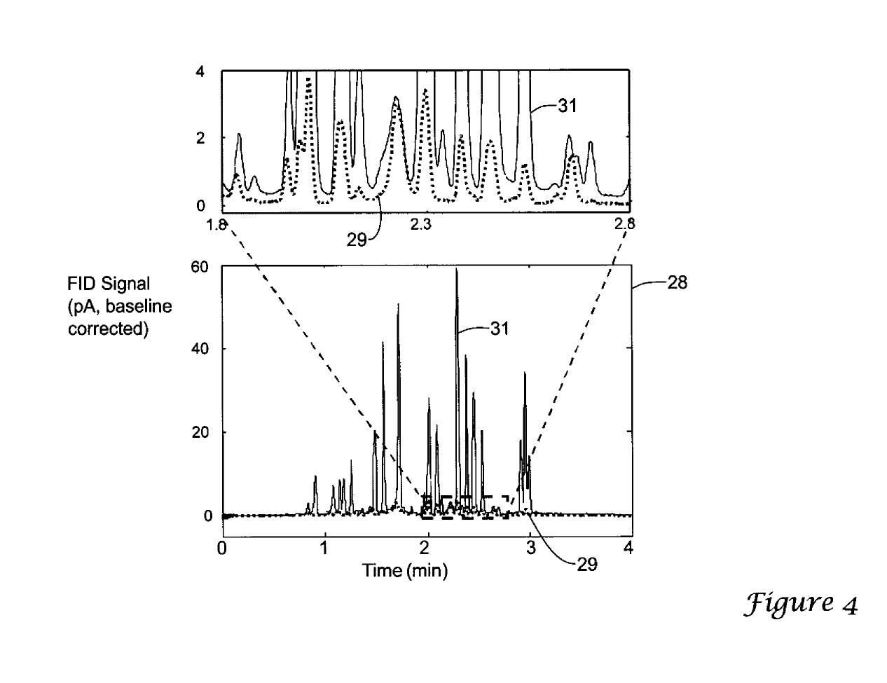

A PHASED solution to, for example, analyzing more than 300 analyte samples, may require performing chemical segregation during the sampling procedure. The present sampling protocol and injector arrangement may enable the chemical segregation. FIG. 4 is a graph 28 showing PHASED data supporting chemical segregation. One may start out a standard 3 micro-liter injection of a TO-15 sample. A dotted trace 29 shows the data from the injection. A solid line trace 31 may result from a PHASED concentration and injection. One may note that not all peaks are concentrated. This approach may reveal the selectivity of an adsorbent. The peaks that do not increase in intensity are not necessarily collected by the adsorbent and may be allowed to pass through the first PHASED device and into the next device for possible adsorption and chemical segregation.

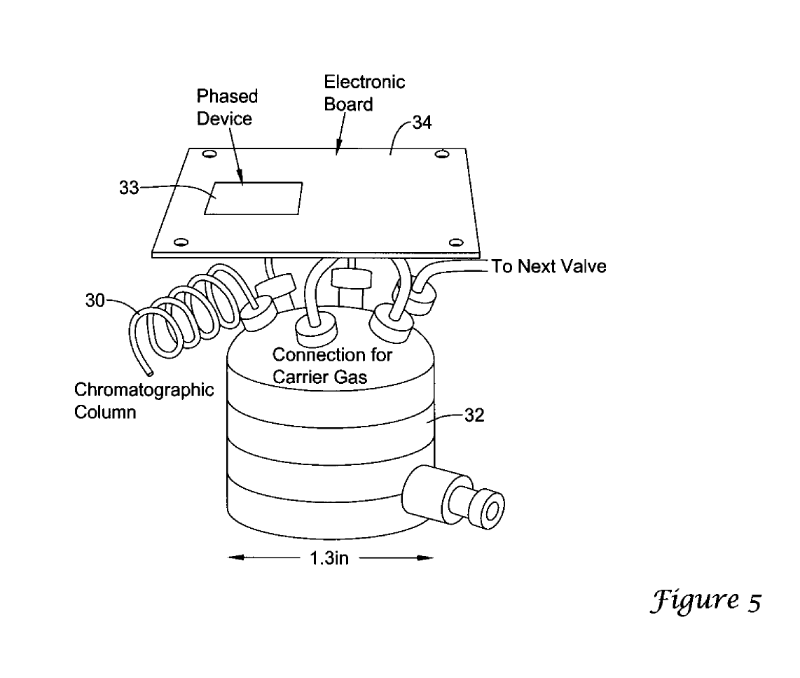

Chemical segregation may be a way of ensuring that chemically incompatible analytes are not introduced to the chromatographic columns. These analytes are not necessarily adsorbed and may pass out of the system without introduction to the columns. The sample may pass through a series of PHASED devices with increasingly strong or various adsorbents within them. Series sampling via the PHASED device may allow a unique aliquot of analytes to be adsorbed within each device. Moreover, the series sampling may ensure that low-vapor pressure sticky analytes do not poison the strongest adsorbents. The aliquots adsorbed in each device may be determined by the chemical property of the respective adsorbents. The devices may be fluidically connected in series during sampling; however, the devices can quickly be parallel-connected by the changing valves for performing injections into their respective chromatographic columns at certain time slots in order to meet a sample cycle time metric. To enable this series sampling and parallel analysis paradigm, each PHASED device may be positioned across high speed, 6-port, 2-position diaphragm valves 11, 12. FIGS. 1 and 2 provide a schematic of the valves indicating the fluidic paths for series arranged segregation and parallel analysis position. The PHASED concentrator/injector 13, 14 may be placed external to the valve connected at ports 2 and 5. This structural scheme may include additional valves and PHASED concentrator/injectors. Each of the valves may be approximately 3.3 cm (1.3 in) in diameter. FIG. 5 shows a perspective diagram of an illustrative example valve 32 which may be used as a valve in the present system.

During sampling and chemical segregation, the sample at symbol 19 may enter the valve 11 at port 1 and exit at port 2. The sample may then pass through the PHASED concentrator/injector 13 where a chemical class of reagents is adsorbed. The remaining sample may pass back into the valve 11 at port 5 and exit to the next valve 12 at port 6. The sixth port of each valve may be connected to the first port of the subsequent valve. In this manner, the sample may pass through several PHASED concentrator/injectors 13, 14 in series. As indicated herein, there may be more PHASED concentrator/injectors, after the concentrator/injector 14, connected in series with corresponding valves. Each PHASED concentrator may be responsible for adsorbing a unique class of compounds. A rendering of the PHASED device 13, 14 connected to a valve is shown in FIGS. 1 and 2. Two connections lead to the PHASED device, while a port in the rear of the rendering is where sample is introduced. An actuation of the valves 11, 12 may alternate the PHASED devices 13, 14 between a series connection and a parallel connection where each PHASED device 13, 14 is inserted between the carrier gas source at symbol 15, 17 and, for instance, a chromatographic column at symbol 16, 18. The operation may be the same for additional PHASED devices. The diagram of FIG. 5 is a rendering of PHASED device 33, with supporting electronics 34, connected to the VICI valve 32 in an arrangement that facilitates chemical segregation prior to parallel analysis with a chromatographic column 30. VICI valves may be obtained from Valco Instruments Co. Inc.

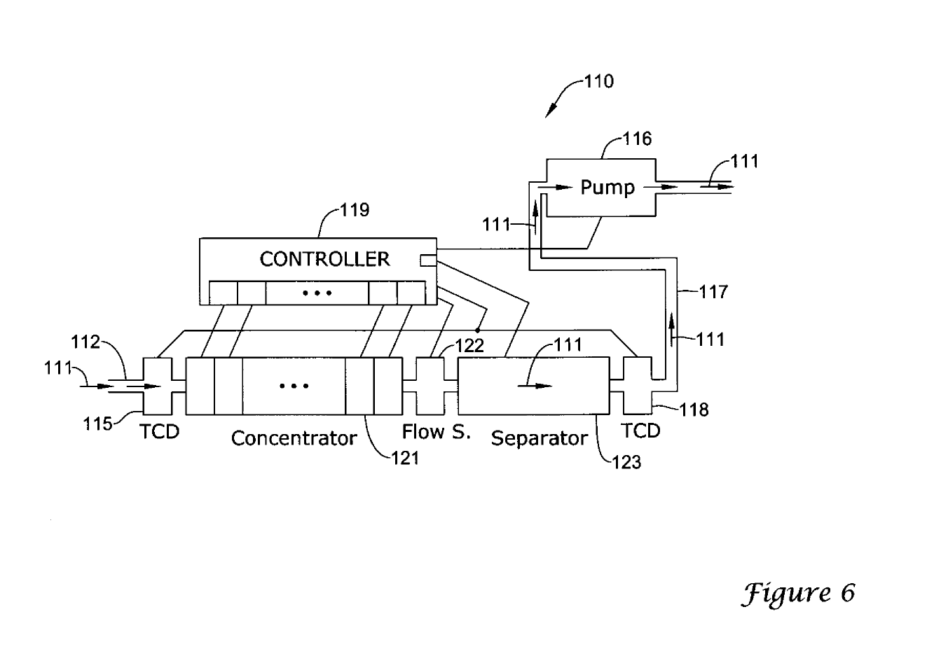

FIGS. 6-9 are diagrams of an illustrative example a fluid analyzer which may be a phased heater array structure for enhanced detection (PHASED) micro gas analyzer (MGA) 110. Variants of the PHASED analyzer may be used in the present approach. FIG. 6 is an overall diagram revealing certain details of the micro gas apparatus 110 which may be encompassed in the specially designed devices 13 and 14 described herein.

Sample stream 111 may enter input port 112 to the first leg of a differential thermal-conductivity detector (TCD) (or other device) 115. A pump 116 may effect a flow of fluid 111 through the apparatus 110 via tube 117. There may be one or more additional pumps, and various tube or plumbing arrangements or configurations for system 110 in FIG. 6. Fluid 111 may be moved through a TDC 115, concentrator 121, flow sensor 122, separator 123 and TDC 118. Controller 119 may manage the fluid flow, and the activities of concentrator 121 and separator 123. Controller 119 may be connected to TCD 115, concentrator 121, flow sensor 122, separator 123, TCD 118, and pump 116. Data from detectors 115 and 118, and sensor 122 may be sent to controller 119, which in turn may process the data. The concentrator may be or referred to as a collector or other comparable item. The term “fluid” may refer to a gas or a liquid, or both.

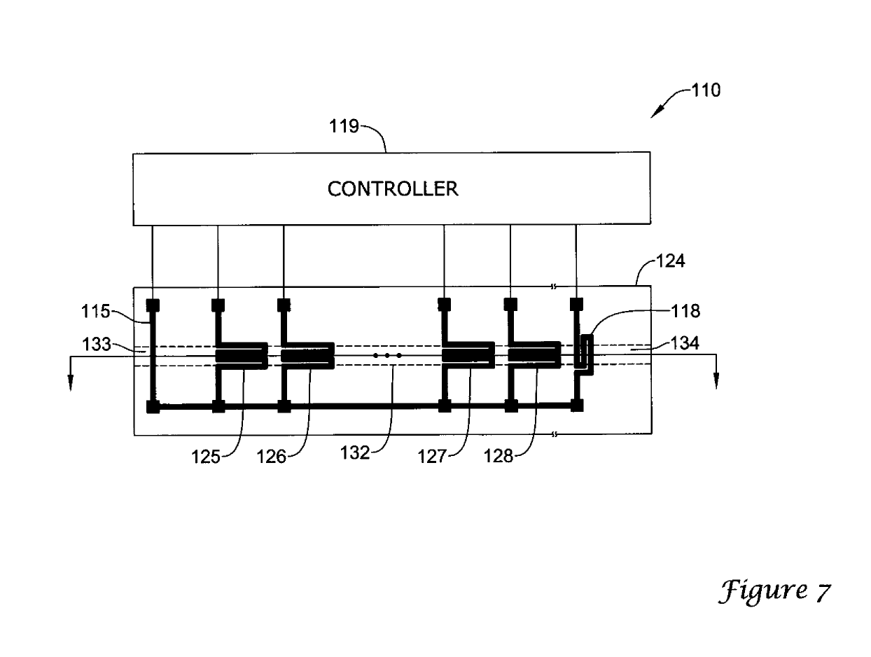

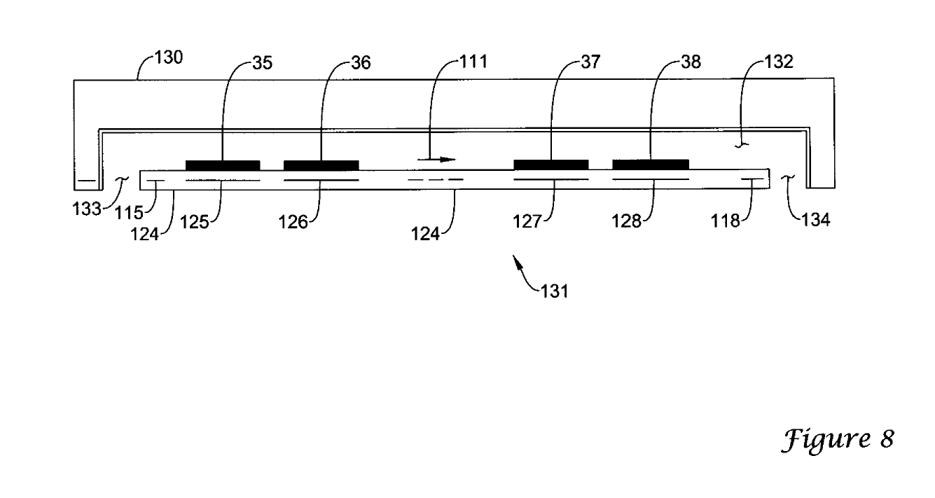

FIG. 7 is a schematic diagram of part of the sensor apparatus 110 representing a heater portion of concentrator 121 and/or separator 123 in FIG. 6. This part of sensor apparatus 110 may include a substrate or holder 124 and controller 119. Controller 119 may or may not be incorporated into substrate 124. Substrate 124 may have a number of thin film heater elements 125, 126, 127, and 128 positioned thereon. While only four heater elements are shown, any number of heater elements may be provided, for instance, between two and one thousand, but typically in the 20-100 range. Heater elements 125, 126, 127, and 128 may be fabricated of any suitable electrical conductor, stable metal, alloy film, or other material. Heater elements 125, 126, 127, and 128 may be provided on a thin, low-thermal mass, low-in-plane thermal conduction, membrane, substrate or support member 124, as shown in FIGS. 7 and 8. The heater elements may instead be or referred to as temperature control components or other comparable items. There may instead be just one element or component.

In FIG. 8, substrate 130 may have a well-defined single-channel phased heater mechanism and channel structure 131 having a channel 132 for receiving the sample fluid stream 111. The channel may be fabricated by selectively etching a silicon channel wafer substrate 130 near the support member 124. The channel may include an entry port 133 and an exhaust port 134.

The sensor apparatus 110 may also include a number of interactive elements inside channel 132 so that they are exposed to the streaming sample fluid 111. Each of the interactive elements may be positioned adjacent, i.e., for closest possible thermal contact, to a corresponding heater element. For example, in FIG. 8, interactive elements 35, 36, 37, and 38 may be provided on a surface of support member 124 in channel 132, and be adjacent to heater elements 125, 126, 127, and 128, respectively. There may be detectors 115 and 118 at the ends of channel 132.

There may be other channels having interactive film elements which are not shown in the present illustrative example. The interactive elements may be films formed from any number of substances commonly used in liquid or gas chromatography. Furthermore, the interactive substances may be modified by suitable dopants to achieve varying degrees of polarity and/or hydrophobicity, to achieve optimal adsorption, segregation and/or separation of targeted analytes.

The micro gas analyzer 110 may have interactive elements 35, 36, . . . , 37 and 38 fabricated with various approaches, such that there is a pre-arranged pattern of concentrator and separator elements coated with different adsorber materials A, B, C, . . . (i.e., stationary phases in gas chromatography (GC)). Not only may the ratio of concentrator 121 / separator 123 elements be chosen, but also which elements are coated with A, B, C, . . . , and so forth, may be determined (and with selected desorption temperatures) to contribute to the concentration and separation process. A choice of element temperature ramping rates may be chosen for the A's which are different for the B, C, . . . , elements. Versatility may be added to this system in a way that after separating the gases from the group of “A” elements, another set of gases may be separated from the group of “B” elements, and so forth.

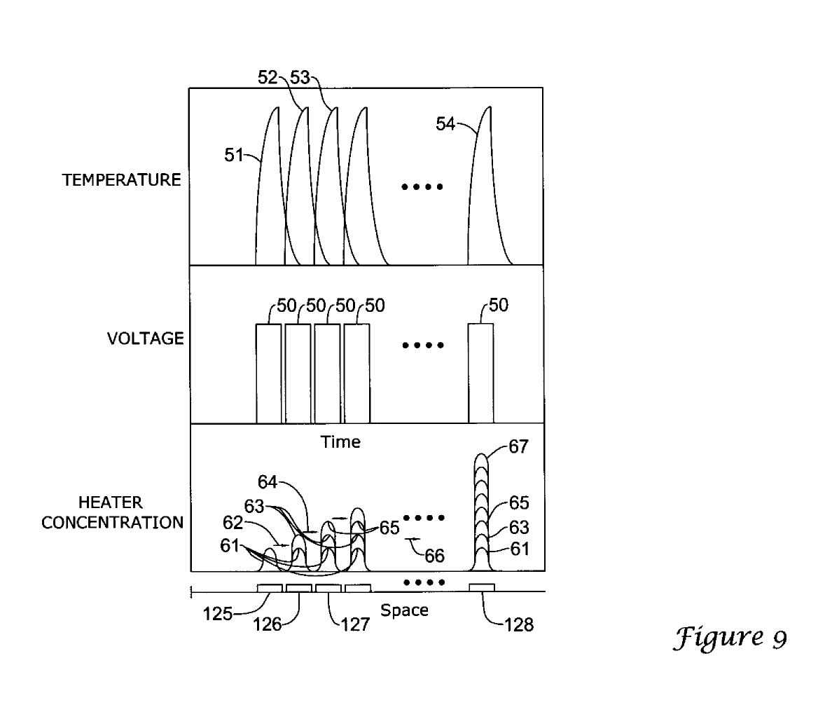

Controller 119 may be electrically connected to each of the heater elements 125, 126, 127, 128, and detectors 115 and 118 as shown in FIG. 7. Controller 119 may energize heater elements 125, 126, 127 and 128 in a time phased sequence (see bottom of FIG. 9) such that each of the corresponding interactive elements 35, 36, 37, and 38 become heated and desorb selected constituents into a streaming sample fluid 111 at about the time when an upstream concentration pulse, produced by one or more upstream interactive elements, reaches the interactive element. Any number of interactive elements may be used to achieve the desired concentration of constituent gases in the concentration pulse. The resulting concentration pulse may be sensed by detector 118 for analysis by controller 119.

FIG. 9 is a graph showing illustrative relative heater temperatures, along with corresponding concentration pulses produced at each heater element. As indicated herein, controller 119 may energize heater elements 125, 126, 127 and 128 in a time phased sequence with voltage signals 50. Time phased heater relative temperatures for heater elements 125, 126, 127, and 128 may be shown by temperature profiles or lines 51, 52, 53, and 54, respectively.

In the example shown, controller 119 (FIG. 7) may first energize heater element 125 to increase its temperature as shown at line 51 of FIG. 9. Since the first heater element 125 is thermally coupled to first interactive element 35 (FIG. 8), the first interactive element desorbs selected constituents into the streaming sample fluid 111 to produce a first concentration pulse 61 (FIG. 9), while no other heater elements are not yet pulsed. The streaming sample fluid 111 carries the first concentration pulse 61 downstream toward second heater element 126, as shown by arrow 62.

Controller 119 may next energize second heater element 126 to increase its temperature as shown at line 52, starting at or before the energy pulse on element 125 has been stopped. Since second heater element 126 is thermally coupled to second interactive element 36, the second interactive element also desorbs selected constituents into streaming sample fluid 111 to produce a second concentration pulse. Controller 119 may energize second heater element 126 in such a manner that the second concentration pulse substantially overlaps first concentration pulse 61 to produce a higher concentration pulse 63, as shown in FIG. 9. The streaming sample fluid 111 may carry the larger concentration pulse 63 downstream toward third heater element 127, as shown by arrow 64.

Controller 119 may then energize third heater element 127 to increase its temperature as shown at line 53 in FIG. 9. Since third heater element 127 is thermally coupled to the third interactive element 37, the third interactive element 37 may desorb selected constituents into the streaming sample fluid to produce a third concentration pulse. Controller 119 may energize the third heater element 127 such that the third concentration pulse substantially overlaps the larger concentration pulse 63, provided by the first and second heater elements 125 and 126, to produce an even larger concentration pulse 65. The streaming sample fluid 111 may carry this larger concentration pulse 65 downstream toward an “Nth” heater element 128, as shown by arrow 66.

Controller 119 may then energize “N-th” heater element 128 to increase its temperature as shown at line 54. Since “N-th” heater element 128 is thermally coupled to an “N-th” interactive element 38, “N-th” interactive element 38 may desorb selected constituents into streaming sample fluid 111 to produce an “N-th” concentration pulse. Controller 119 may energize “N-th” heater element 128 in such a manner that the “N-th” concentration pulse substantially overlaps the large concentration pulse 65 as provided by the previous N−1 interactive elements, to produce a larger concentration pulse 67. The streaming sample fluid 111 may carry the resultant “N-th” concentration pulse 67 to either a separator 123 and/or a detector 118.

Relevant patent documents may incorporate: U.S. Pat. No. 6,393,894 B1, issued May 28, 2002, and entitled “GAS SENSOR WITH PHASED HEATERS FOR INCREASED SENSITIVITY”, which is incorporated herein by reference; U.S Pat. No. 6,792,794 B2, issued Sep. 21, 2004, and entitled “LOW POWER GAS LEAK DETECTOR”, which is incorporated herein by reference; U.S. Pat. No. 7,104,112 B2, issued Sep. 12, 2006, and entitled “PHASED MICRO ANALYZER IV”, which is incorporated herein by reference; U.S. Pat. No. 7,367,216 B2, issued May 6, 2008, and entitled “PHASED MICRO ANALYZER VIII”, which is incorporated herein by reference; U.S. Pat. No. 7,502,109 B2, issued Mar. 10, 2009, and entitled “OPTICAL MICRO-SPECTROMETER”, which is incorporated herein by reference; U.S. Pat. No. 7,518,380 B2, issued Apr. 14, 2009, and entitled “CHEMICAL IMPEDANCE DETECTORS FOR FLUID ANALYZERS”, which is incorporated herein by reference; U.S. Pat. No. 7,530,257 B2, issued May 12, 2009, and entitled “PHASED MICRO ANALYZER VIII”, which is incorporated herein by reference; U.S. Pat. No. 7,578,167 B2, issued Aug. 25, 2009, and entitled “THREE-WAFER CHANNEL STRUCTURE FOR A FLUID ANALYZER”, which is incorporated herein by reference; U.S. Patent Application Pub. No. 2004/0175837 A1, published Sep. 9, 2004, and entitled “COMPACT OPTO-FLUIDIC CHEMICAL SENSOR”, which is incorporated herein by reference; U.S. Patent Application Pub. No. 2004/0223882 A1, published Nov. 11, 2004, and entitled “MICRO-PLASMA SENSOR SYSTEM”, which is incorporated herein by reference; U.S. Patent Application Pub. No. 2004/0224422 A1, published Nov. 11, 2004, and entitled “PHASED MICRO ANALYZER III, IIIA”, which is incorporated herein by reference; U.S. Patent Application Pub. No. 2004/0245993 A1, published Dec. 9, 2004, and entitled “GAS IONIZATION SENSOR”, which is incorporated herein by reference; U.S. Patent Application Pub. No. 2005/0142035 A1, published Jun. 30, 2005, and entitled “MICRO-DISCHARGE SENSOR SYSTEM”, which is incorporated herein by reference; U.S. Patent Application Pub. No. 2005/0181245 A1, published Aug. 18, 2005, and entitled “HYDROGEN AND ELECTRICAL POWER GENERATOR”, which is incorporated herein by reference; U.S. Patent Application Pub. No. 2009/0184724 A1, published Jul. 23, 2009, and entitled “CHEMICAL IMPEDANCE DETECTORS FOR FLUID ANALYZERS”, which is incorporated herein by reference; and U.S. Patent Application Pub. No. 2007/0274867 A1, published Nov. 29, 2007, and entitled “STATIONARY PHASE FOR A MICRO FLUID ANALYZER”, which is incorporated herein by reference.

In the present specification, some of the matter may be of a hypothetical or prophetic nature although stated in another manner or tense.

Although the present system has been described with respect to at least one illustrative example, many variations and modifications will become apparent to those skilled in the art upon reading the specification. It is therefore the intention that the appended claims be interpreted as broadly as possible in view of the prior art to include all such variations and modifications.

What is claimed is:

1. A system for segregation, comprising:
a fluid control mechanism;
a first device connected to the fluid control mechanism;
a second device connected to the fluid control mechanism;
a first analyzer connected to the fluid control mechanism; and
a second analyzer connected to the fluid control mechanism; and
wherein:
the fluid control mechanism is for selecting a connection between the first and second devices or a connection between the devices and respective analyzers; and
the devices are for segregation of fluids according to a property or properties of the fluids.

2. The system of claim 1, wherein each device comprises:
a channel;
one or more temperature control components situated in the channel; and
an adsorption material situated proximate to the one or more temperature control components.

3. The system of claim 2, wherein the fluid control mechanism comprises:
an input port;
an output port; and
wherein:
the fluid control mechanism has a first selection and a second selection;
the first selection connects the input port to an input of the first device, an output of the first device to an input of a second device, and an output of the second device to the output port; and
the second selection connects the input of the first device to a gas source, the output of the first device to a first analyzer, the input of the second device to the gas source, and an output of the second device to a second analyzer.

4. The system of claim 3, wherein each of the plurality temperature control components may cool or heat the adsorption material to assist in the segregation of fluids according to a property or properties of the fluids.

5. The system of claim 3, wherein:
the first selection of the fluid control mechanism permits a sample to go through the channel of the first device and through the channel of the second device;
a first set of analytes of the sample are effectively adsorbed by the adsorption material in the channel of the first device; and
a second set of analytes of the sample are effectively adsorbed by the adsorption material in the channel of the second device.

6. The system of claim 5, wherein the second selection of the fluid control mechanism permits the first set of analytes to be desorbed from the adsorption material in the channel of the first device and conveyed to the first analyzer, and the second set of analytes to be desorbed from the adsorption material in the channel of the second device and conveyed to the second analyzer.

7. The system of claim 6, wherein:
the first set of analytes is adsorbed according one or more properties of the first set of analytes;
the second set of analytes is adsorbed according to one or more properties of the second set of analytes; and
one or more properties of the analytes adsorbed by an adsorption material are different than one or more properties of analytes adsorbed by another adsorption material of the two or more adsorption materials.

8. The system of claim 7, wherein the segregation of fluids according to a property or properties is not necessarily 100 percent perfect.

9. The system of claim 3, further comprising additional devices and analyzers connected to the fluid control mechanism similarly as the first and second devices and the first and second analyzers.

10. The system of claim 6, wherein:
the first set of analytes is desorbed from the adsorption material by the one or more temperature control components in the channel of the first device; and
the second set of analytes is desorbed from the adsorption material by the one or more temperature control components in the channel of the second device.

11. The system of claim 10, wherein:
each component of the one or more temperature control components is fired in a sequential order to provide a pulse of temperature change and a corresponding pulse of analytes desorbed by fired temperature control components, which move in synch with a flow of gas carrying the pulse of analytes; and
upon the second selection of the fluid control mechanism, the pulse of analytes of the first device and the pulse of analytes of the second device are conveyed to the first and second analyzers, respectively.

12. The system of claim 11, wherein:
the first analyzer comprises a separator; and
the second analyzer comprises a separator.

13. The system of claim 11, wherein upon conveyance of the pulse of analytes of the first device and the pulse of analytics analytes of the second device, the first selection of the fluid conveyance mechanism is made to permit a sample through the channel of the first device and the channel of the second device for adsorption and desorption to obtain additional pulses of analytes, respectively.

14. A method for segregating a sample, comprising:
providing a sample to a plurality of collector devices connected in series by a routing mechanism in a first mode;
segregating a portion or all of the sample into a plurality of groups of analytes according to properties of the analytes; and
injecting the plurality of groups of analytes from the plurality of collector devices, connected in parallel with a plurality of analyzers by the routing mechanism in a second mode, into the plurality of analyzers, respectively.

15. The method of claim 14, wherein:
a property of the analytes adsorbed by a collector device is different than a property of analytes adsorbed by another collector device of the two or more concentrators;
each collector device of the plurality of collectors desorbs the analytes into a pulse of analytes; and
the pulse of the analytes is formed from a sequence of firings of temperature control components along an adsorption material resulting in a pulse desorbing analytes adsorbed in the adsorptive material accumulating into the pulse of analytes, the pulses having a movement coinciding with a movement of a carrier gas carrying the pulse of analytes which is a group of analytes.

16. The method of claim 15, wherein each of the plurality of analyzers comprises a separator.

17. A system for separating a sample for analysis, comprising:
two or more fluid control mechanisms;
two or more devices connected to the two or more fluid control mechanisms, respectively;
two or more analyzers connected to the two or more fluid control mechanisms, respectively; and
wherein:
each of the two or more fluid control mechanisms has a selector having a first position and a second position;
the first position of the two or more fluid control mechanisms connects the two or more devices in series with one another;
the second position connects the two or more devices in parallel with the two or more analyzers, respectively; and
the two or more devices are collectors;
each collector adsorbs analytes having a property; and
a property of the analytes adsorbed by a collector is different than a property of analytes adsorbed by another collector of the two or more concentrators.

18. The system of claim 17, wherein:
each collector desorbs the adsorbed analytes into a group of analytes having a common property; and
a group of analytes goes to an analyzer connected to a corresponding collector.

19. The system of claim 18, wherein each collector is a PHASED device.

20. The system of claim 18, wherein each analyzer comprises a separator.
